(19) United States
(12) Patent Application Publication
(10) Pub. No.: US 2016/0045850 A1
(43) Pub. Date: Feb. 18, 2016

(54) ONE TYPE OF DUCT AIR PURIFIER

(71) Applicant: Broan Buildign Products Co., Ltd., Huizhou (CN)

(72) Inventors: Stephen Kells Swenerton, Boulder, CO (US); He Zhijun, Hartford, WI (US)

(21) Appl. No.: 14/826,586

(22) Filed: Aug. 14, 2015

(30) Foreign Application Priority Data
Aug. 15, 2014 (CN) 201420464132.5

(51) Int. Cl. B01D 46/00; B01D 46/42; B01D 46/44

(52) U.S. Cl. CPC B01D 46/0023; B01D 46/442; B01D 46/0036; B01D 46/009; B01D 46/4254

(57) ABSTRACT

The present utility model relates to an air purifier, in particular to a duct-type air purifier. To overcome the inadequacies of existing air purifiers in being unable to effectively absorb dust in high-level air indoors and taking up a user's usable space, the present utility model provides a duct-type air purifier. The purifier comprises a panel assembly, a basic-efficiency filter, a high-efficiency filter, a middle frame assembly, an air duct sealing element, a motor air duct assembly, a box assembly, an air outlet assembly and a ventilation duct. The air purifier is installed on the ceiling of a room, and can not only effectively absorb pollutants such as dust in high-level air, but also save indoor space for a user, and purify air in multiple rooms simultaneously.

### TECHNICAL FIELD

The present utility model relates to an air purifier, in particular to a duct-type air purifier.

### BACKGROUND ART

At present, most known indoor air purifiers have a tabletop or standing structure, and must be arranged on a table or floor during use. However, large amounts of dust in indoor air, including partly respirable particles (particulates with a particle size of 10 microns or less are generally called PM10, and also called respirable particulates or air-borne dust) and very fine particulates (which means particulates in the atmosphere with a diameter less than or equal to 2.5 microns, commonly called PM2.5), are suspended in high-level air indoors due to the effect of buoyancy. The absorption effect of conventional tabletop or standing air purifiers on such dust is limited. Moreover, conventional tabletop or standing air purifiers must be arranged on a table or floor, taking up usable indoor space, and causing great inconvenience.

### CONTENT OF THE INVENTION

To overcome the inadequacies of existing air purifiers in being unable to effectively absorb dust in high-level air indoors and taking up a user's usable space, the present utility model provides a duct-type air purifier. The air purifier is fixed to the roof and/or ceiling of a room, and can not only effectively absorb pollutants such as dust in high-level air, but also save a user's usable space.

To solve the above technical problem, the present utility model employs the following technical solution:

The present invention provides a duct-type air purifier, comprising a panel assembly, a basic-efficiency filter, a high-efficiency filter, a middle frame assembly, an air duct sealing element, a motor air duct assembly, a box assembly (which can be abbreviated as box), and an air outlet assembly; the air outlet assembly is installed on a side of the box assembly; the air duct sealing element is installed in the box, and the motor air duct assembly is installed in the air duct sealing element; the motor air duct assembly comprises an air intake end, a wind wheel and an air output end, an opening is disposed on a side of the air duct sealing element, and the air output end is in communication with the air outlet assembly via the opening on the side of the air duct sealing element; the middle frame assembly is installed on the air duct sealing element, and the high-efficiency filter, basic-efficiency filter and panel assembly are installed on the middle frame assembly in sequence from the inside to the outside; an air inlet is formed between the panel assembly and middle frame assembly.

Under the sucking action of the wind wheel of the motor air duct assembly, indoor air enters the interior of the box through the air inlet formed between the panel assembly and middle frame assembly, is filtered by the basic-efficiency filter and high-efficiency filter, passes through the air duct sealing element, the air intake end of the motor air duct assembly, and the air output end of the motor air duct assembly, and is discharged from the air outlet assembly on the side of the box.

The air discharged by the air outlet assembly is blown out in a horizontal direction.

The air inlet is located above the three sides of the box assembly other than that side on which the air outlet assembly is installed.

Once the motor air duct assembly is powered on, the wind wheel rotates to generate a sucking force, and the air purifier begins to purify indoor air; once the motor air duct assembly is powered off, the wind wheel gradually stops, and no longer generates a sucking force, at which time the air purifier stops operating.

The duct-type air purifier described above is installed on a ceiling, with the air outlet assembly being connected to a universal ventilation duct, and being able to supply filtered fresh air to multiple rooms simultaneously.

Furthermore, in the air purifier, the box assembly can be fixed to a roof or ceiling.

Furthermore, the air purifier further comprises a ventilation duct, an inlet of the ventilation duct being in communication with the air outlet assembly, and the ventilation duct having multiple air outlets.

The multiple air outlets of the ventilation duct are distributed in different rooms.

Furthermore, in the air purifier, the box assembly comprises a box body, with one face of the box body being an opening, and the panel assembly being located at the opening.

Furthermore, in the air purifier, a fan is disposed in the air outlet assembly, the fan being used for delivering filtered fresh air to a ventilation duct, and the fresh air is discharged from an air outlet of the ventilation duct.

Furthermore, a fan is also disposed in the ventilation duct, to deliver filtered fresh air to the air outlet of the ventilation duct.

Angle iron brackets are installed on external sides of the box assembly. The angle iron brackets are used for installing the air purifier on a roof or ceiling.

The box assembly further comprises installation hanger rods connected to the angle iron brackets. The installation hanger rods may be installation threaded rods. The installation hanger rods can suspend the box assembly beneath a roof.

Furthermore, in the air purifier, the air outlet assembly comprises an installation plate and an air output duct, the air output duct being installed on a side of the box by means of the installation plate.

Furthermore, in the air purifier, the air outlet assembly is an air output duct installed on a side of the box.

Furthermore, in the air purifier, the panel assembly is fixed to the middle frame assembly by means of a fixed rotation shaft and a holding magnet; that side of the panel assembly which is provided with the holding magnet is opened, and the panel assembly is rotated unilaterally by means of the fixed rotation shaft on another side.

An advantage of such a design of panel assembly is that there is no need to remove the panel assembly when a filter is to be replaced or cleaned.

Furthermore, in the air purifier, the basic-efficiency filter is of nylon material, while the high-efficiency filter is formed of a combination of two layers of material, namely high-density composite paper and activated carbon.

The basic-efficiency filter mainly filters suspended particles in indoor air; the high-efficiency filter mainly filters fine particulates and harmful gases in indoor air.

Furthermore, the air purifier comprises a sensor for measuring a particulate concentration in air; when the particulate concentration exceeds a certain value, the sensor can automatically turn on the wind wheel, and when the particulate concentration falls to a certain value, the sensor can automatically turn off the wind wheel.

Furthermore, the air purifier comprises an indicator lamp, the indicator lamp comprising a red signal lamp and a blue signal lamp, and the sensor is able to control the indicator lamp; when the particulate concentration detected by the sensor reaches a certain value, the air purifier begins to operate in a first running mode, and the red signal lamp on the air purifier lights up; when the particulate concentration is lower than a certain value, the air purifier begins to operate in a second running mode, and the blue signal lamp lights up; the blue signal lamp remains lit until the air purifier begins to operate in the first running mode again.

When the air purifier is operating in the first running mode, the wind wheel rotates at high speed, and the air purifier operates with high efficiency. When the air purifier is operating in the second running mode, the wind wheel rotates at low speed, and the efficiency with which the air purifier purifies air is lower.

When it is necessary to turn off the air purifier, a manual form of turn-off is employed: the power supply is disconnected. The indicator lamp on the air purifier is extinguished.

Furthermore, the air purifier comprises a remote controller, the remote controller comprising a manual mode and an automatic mode; when the remote controller is in the automatic mode, the sensor automatically begins to operate.

Furthermore, the air purifier comprises a main control circuit board; the main control circuit board is used for receiving signals transmitted by the sensor, and turning the wind wheel on or off according to the signals transmitted by the sensor.

Furthermore, in the air purifier, the high-efficiency filter comprises an electronic indicating means, for indicating whether the high-efficiency filter has been installed properly; once installation of the high-efficiency filter is complete, the electronic indicating means transmits a signal to the main control circuit board, and the main control circuit board puts the air purifier into a state in which the latter is able to operate.

The air purifying function of the product is mainly realized through two-stage filtration by two filter elements. Indoor air first passes through the basic-efficiency filter, which is of nylon material and mainly filters fine hair, hairs and large-radius suspended particles in indoor air; the air then passes through the high-efficiency filter, which is formed of a combination of two layers of material, namely high-density composite paper and activated carbon. The high-density composite paper can mainly filter very fine particulates in indoor air; the activated carbon can adsorb harmful gases. The basic-efficiency filter can be washed in water and used repeatedly; the high-efficiency filter must be replaced periodically to guarantee the purification effect.

The box assembly of the duct-type air purifier provided by the present utility model may be installed on a roof or ceiling, to achieve the objective of sucking in indoor air at all heights from the top of a room and performing purification.

Compared to existing tabletop or standing indoor air purifiers, the indoor air purifier provided in the present application can effectively remove respirable particles, very fine particulates and bacteria etc. from air, can save usable indoor space, and can supply filtered fresh air to multiple rooms simultaneously. In addition, the duct-type air purifier provided by the present application can be installed and dismantled conveniently, enables the primary filter to be removed easily for cleaning, and enables the high-level filter to be replaced easily.

### DESCRIPTION OF THE ACCOMPANYING DRAWINGS

FIG. 1 is a schematic diagram showing how the duct-type air purifier provided by the present utility, model is assembled;

FIG. 2 is a view of the duct-type air purifier from below;

FIG. 3 is a side view of the duct-type air purifier;

FIG. 4 is a perspective drawing of the duct-type air filter suspended below a roof;

FIG. 5 is a schematic diagram of an air flow route in the purifier.

In the figure: 1 is the panel assembly, 2 is the basic-efficiency filter, 3 is the high-efficiency filter, 4 is the middle frame assembly, 5 is the air duct sealing element, 6 is the motor air duct assembly, 7 is the box assembly, 8 is the air outlet assembly; 101 is the air inlet; 501 is the opening disposed in the air duct sealing element; 601 is the air intake end of the motor air duct assembly, 603 is the air output end of the motor air duct assembly; 701 is the angle iron bracket, 702 is the hanger rod, 300 is the roof; 801 is the installation plate, 802 is the air output duct, 803 is the fan; 100 is dirty air, 200 is fresh air.

### PARTICULAR EMBODIMENTS

The present utility model is explained further below in conjunction with the accompanying drawings and embodiments.

### Embodiment 1

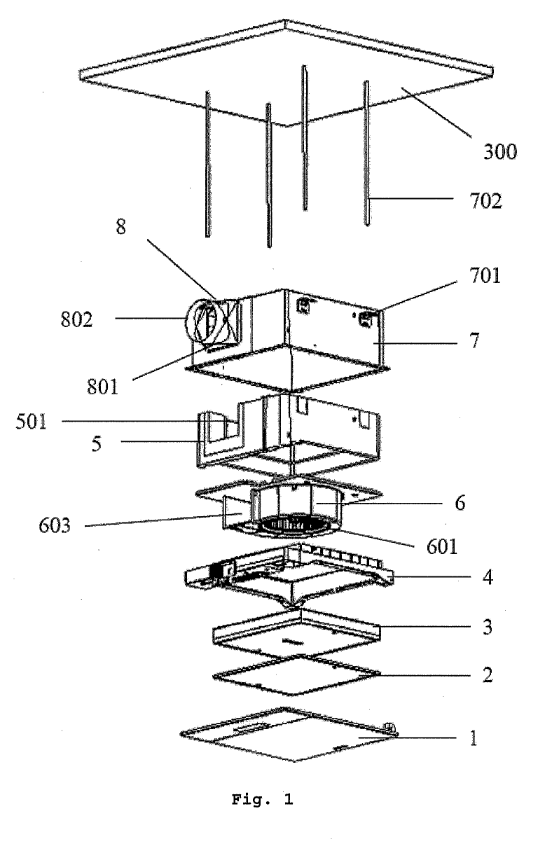

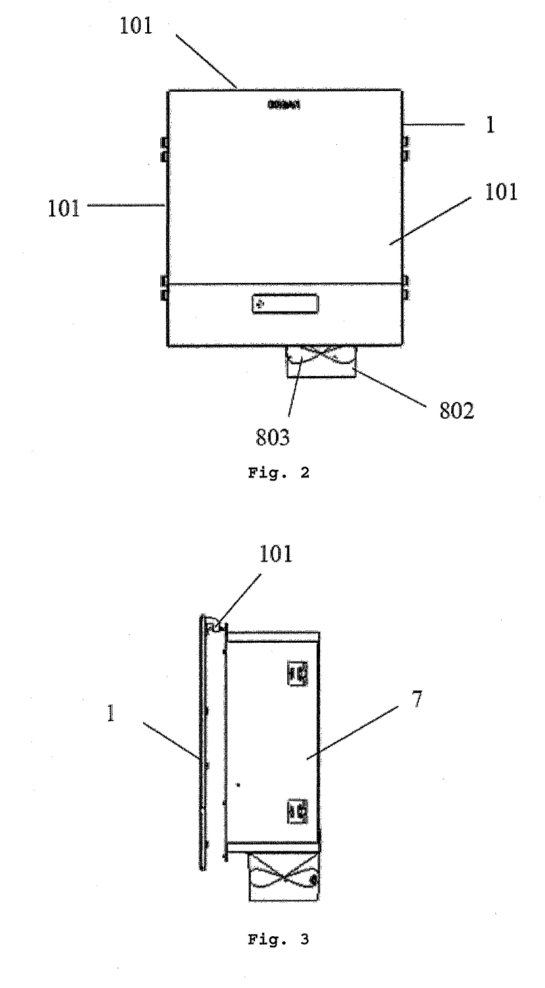

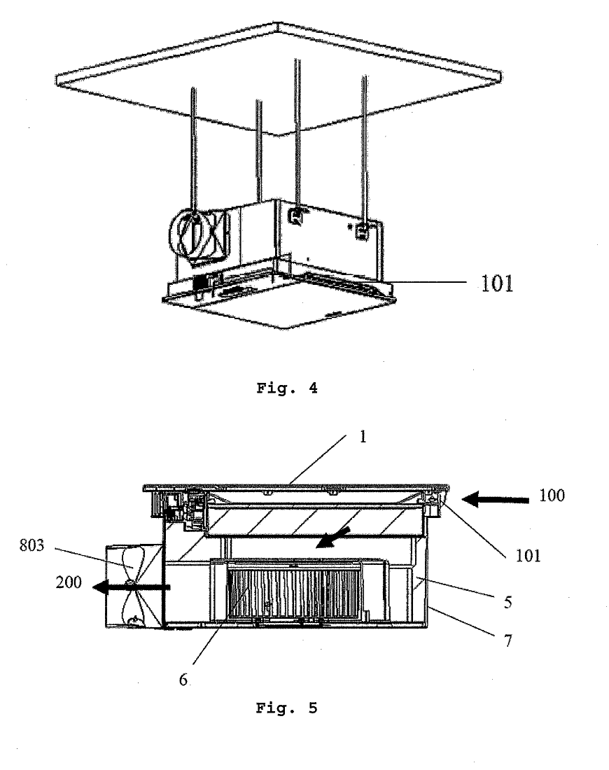

As FIGS. 1 to 5 show, the present invention provides a duct-type air purifier, comprising a panel assembly 1, a basic-efficiency filter 2, a high-efficiency filter 3, a middle frame assembly 4, an air duct sealing element 5, a motor air duct assembly 6, a box assembly 7, and an air outlet assembly 8; the air outlet assembly 8 is installed on a side of the box assembly 7; the air duct sealing element 5 is installed in the box 7, and the motor air duct assembly 6 is installed in the air duct sealing element 5; the motor air duct assembly 6 comprises an air intake end 601, a wind wheel and an air output end 603, an opening 501 is disposed on a side of the air duct sealing element 5, and the air output end 603 is in communication with the air outlet assembly 8 via the opening 501 on the side of the air duct sealing element 5; the middle frame assembly 4 is installed on the air duct sealing element 5, and the high-efficiency filter 3, basic-efficiency filter 2 and panel assembly 1 are installed on the middle frame assembly 4 in sequence from the inside to the outside; an air inlet 101 is formed between the panel assembly 1 and middle frame assembly 4.

Under the sucking action of the wind wheel of the motor air duct assembly 6, indoor air enters the interior of the box 7 through the air inlet 101 formed between the panel assembly 1 and middle frame assembly 4, is filtered by the basic-efficiency filter 2 and high-efficiency filter 3, passes through the air duct sealing element 5, the air intake end 601 of the motor air duct assembly 6, and the air output end 603 of the motor air duct assembly, and is discharged from the air outlet assembly 8 on the side of the box.

The air discharged by the air outlet assembly is blown out in a horizontal direction.

The air inlet is located above the three sides of the box assembly other than that side on which the air outlet assembly is installed (as shown in FIG. 5).

Once the motor air duct assembly is powered on, the wind wheel rotates to generate a sucking force, and the air purifier begins to purify indoor air; once the motor air duct assembly is powered off, the wind wheel gradually stops, and no longer generates a sucking force, at which time the air purifier stops operating.

The air purifier further comprises a ventilation duct, an inlet of the ventilation duct being in communication with the air outlet assembly 8, and the ventilation duct having multiple air outlets.

The multiple air outlets of the ventilation duct are distributed in different rooms.

A fan 803 is disposed in the air outlet assembly 8, the fan 803 being used for delivering filtered fresh air 200 to the ventilation duct, and the fresh air 200 is discharged from the air outlets of the ventilation duct.

Angle iron brackets 701 are installed on external sides of the box assembly. The box assembly further comprises installation hanger rods 702 connected to the angle iron brackets 701. The installation hanger rods can suspend the box assembly 7 beneath a roof 300.

The air outlet assembly 8 comprises an installation plate 801 and an air output duct 802, the air output duct 802 being installed on a side of the box 7 by means of the installation plate 801.

The panel assembly is fixed to the middle frame assembly by means of a fixed rotation shaft and a holding magnet; that side of the panel assembly which is provided with the holding magnet is opened, and the panel assembly is rotated unilaterally by means of the fixed rotation shaft on another side.

### Embodiment 2

The present invention provides an air purifier as described in embodiment 1, and furthermore, the air purifier comprises a sensor for measuring a particulate concentration in air; when the particulate concentration exceeds a certain value, the sensor can automatically turn on the wind wheel, and when the particulate concentration falls to a certain value, the sensor can automatically turn off the wind wheel.

The air purifier comprises an indicator lamp, the indicator lamp comprising a red signal lamp and a blue signal lamp, and the sensor is able to control the indicator lamp; when the particulate concentration detected by the sensor reaches a certain value, the air purifier begins to operate in a first running mode, and the red signal lamp on the air purifier lights up; when the particulate concentration is lower than a certain value, the air purifier begins to operate in a second running mode, and the blue signal lamp lights up; the blue signal lamp remains lit until the air purifier begins to operate in the first running mode again.

The air purifier comprises a remote controller, the remote controller comprising a manual mode and an automatic mode; when the remote controller is in the automatic mode, the sensor automatically begins to operate.

The air purifier comprises a main control circuit board; the main control circuit board is used for receiving signals transmitted by the sensor, and turning the wind wheel on or off according to the signals transmitted by the sensor.

The high-efficiency filter comprises an electronic indicating means, for indicating whether the high-efficiency filter has been installed properly; once installation of the high-efficiency filter is complete, the electronic indicating means transmits a signal to the main control circuit board, and the main control circuit board puts the air purifier into a state in which the latter is able to operate.

The embodiments above are merely preferred embodiments of the present invention, which are not intended to define the scope of protection thereof. All equivalent changes and modifications made according to the content of the present invention shall be included in the patent scope thereof.

1. Duct-type air purifier, characterized in that the purifier comprises a panel assembly, a basic-efficiency filter, a high-efficiency filter, a middle frame assembly, an air duct sealing element, a motor air duct assembly, a box assembly, and an air outlet assembly; the air outlet assembly is installed on a side of the box assembly; the air duct sealing element is installed in the box, and the motor air duct assembly is installed in the air duct sealing element; the motor air duct assembly comprises an air intake end, a wind wheel and an air output end, an opening is disposed on a side of the air duct sealing element, and the air output end is in communication with the air outlet assembly via the opening on the side of the air duct sealing element; the middle frame assembly is installed on the air duct sealing element, and the high-efficiency filter, basic-efficiency filter and panel assembly are installed on the middle frame assembly in sequence from the inside to the outside; an air inlet is formed between the panel assembly and middle frame assembly;
under the sucking action of the wind wheel of the motor air duct assembly, indoor air enters the interior of the box through the air inlet formed between the panel assembly and middle frame assembly, is filtered by the basic-efficiency filter and high-efficiency filter, passes through the air duct sealing element, the air intake end of the motor air duct assembly, and the air output end of the motor air duct assembly, and is discharged from the air outlet assembly on the side of the box.

2. Air purifier according to claim 1, characterized in that the box assembly can be fixed to a roof or ceiling.

3. Air purifier according to claim 1, characterized in that the air purifier further comprises a ventilation duct, an inlet of the ventilation duct being in communication with the air outlet assembly, and the ventilation duct having multiple air outlets.

4. Air purifier according to claim 1, characterized in that the box assembly comprises a box body, with one face of the box body being an opening, and the panel assembly being located at the opening.

5. Air purifier according to claim 1, characterized in that a fan is disposed in the air outlet assembly, the fan being used for delivering filtered fresh air to a ventilation duct, and the fresh air is discharged from an air outlet of the ventilation duct.

6. Air purifier according to claim 1, characterized in that the air outlet assembly comprises an installation plate and an air output duct, the air output duct being installed on a side of the box by means of the installation plate.

7. Air purifier according to claim 1, characterized in that the air outlet assembly is an air output duct installed on a side of the box.

8. Air purifier according to claim 1, characterized in that the panel assembly is fixed to the middle frame assembly by means of a fixed rotation shaft and a holding magnet i that side of the panel assembly which is provided with the holding magnet is opened, and the panel assembly is rotated unilaterally by means of the fixed rotation shaft on another side.

9. Air purifier according to claim 1, characterized in that the basic-efficiency filter is of nylon material, while the high-efficiency filter is formed of a combination of two layers of material, namely high-density composite paper and activated carbon.

10. it purifier according to claim 1, characterized in that the air purifier comprises a sensor for measuring a particulate concentration in air; when the particulate concentration exceeds a certain value, the sensor can automatically turn on the wind wheel, and when the particulate concentration falls to a certain value, the sensor can automatically turn off the wind wheel.

11. Air purifier according to claim 10, characterized in that the air purifier comprises an indicator lamp, the indicator lamp comprising a red signal lamp and a blue signal lamp, and the sensor is able to control the indicator lamp; when the particulate concentration detected by the sensor reaches a certain value, the air purifier begins to operate in a first running mode, and the red signal lamp on the air purifier lights up; when the particulate concentration is lower than a certain value, the air purifier begins to operate in a second running mode, and the blue signal lamp lights up; the blue signal lamp remains lit until the air purifier begins to operate in the first running mode again.

12. Air purifier according to claim 10, characterized in that the air purifier comprises a remote controller, the remote controller comprising a manual mode and an automatic mode; when the remote controller is in the automatic mode, the sensor automatically begins to operate.

13. Air purifier according to claim 10, characterized in that the air purifier comprises a main control circuit board; the main control circuit board is used for receiving signals transmitted by the sensor, and turning the wind wheel on or off according to the signals transmitted by the sensor.

14. Air purifier according to claim 13, characterized in that the high-efficiency filter comprises an electronic indicating means, for indicating whether the high-efficiency filter has been installed properly; once installation of the high-efficiency filter is complete, the electronic indicating means transmits a signal to the main control circuit board, and the main control circuit board puts the air purifier into a state in which the latter is able to operate.
